(19) United States
(12) Patent Application Publication
(10) Pub. No.: US 2023/0173698 A1
(43) Pub. Date: Jun. 8, 2023

(54) BLADE OF HAIR CLIPPER AND HAIR CLIPPER

(71) Applicant: Panasonic Intellectual Property Management Co., Ltd., Osaka (JP)

(72) Inventors: Yuki TANABE, Osaka (JP); Kazuhiro MORISUGI, Shiga (JP)

(21) Appl. No.: 18/074,234

(22) Filed: Dec. 2, 2022

(30) Foreign Application Priority Data
Dec. 6, 2021 (JP) 2021-197776

(51) Int. Cl. B26B 19/06; B26B 19/38

(52) U.S. Cl. CPC B26B 19/063; B26B 19/3846; B26B 19/205

(57) ABSTRACT

Blade of a hair clipper includes a fixed blade, and a movable blade for cutting hair by reciprocating and sliding on fixed blade in one direction. Furthermore, the fixed blade also includes sliding contact surface P2 on which the movable blade can slide, and skin contact surface P3 that can come into contact with skin. In a first state, sliding contact surface P2 is inclined with respect to skin contact surface P3 such that a distance between sliding contact surface P2 and skin contact surface P3 is decreased toward a distal end side of the fixed blade, and movable blade is configured to be slidable on sliding contact surface P2 of fixed blade in an intersecting direction intersecting with the one direction. Distal end part of fixed blade includes uniform part having a uniform thickness in a thickness direction intersecting the one direction and the intersecting direction.

### BACKGROUND

### 1. Technical Field

The present disclosure relates to a blade of a hair clipper and a hair clipper.

### 2. Description of the Related Art

Conventionally, as disclosed in PTL 1, there has been proposed a hair clipper that includes a fixed blade and a movable blade, and cuts hair by reciprocating sliding of the movable blade with respect to the fixed blade.

In PTL 1, a cutting height can be adjusted by sliding the movable blade with respect to the fixed blade in a direction intersecting the reciprocating sliding.

### CITATION LIST

### Patent Literature

PTL 1: Unexamined Japanese Patent Publication No. H05-317537

### SUMMARY

In such a hair clipper capable of adjusting the cutting height, it is preferable to provide a blade capable of setting the cutting height to be shorter.

In addition, even when the cutting height is shortened, it is preferable to reduce the stimulation applied to a skin during use.

Therefore, an object of the present disclosure is to obtain a blade of a hair clipper and a hair clipper capable of setting a cutting height to be shorter while further reducing stimulation applied to the skin during use.

A blade of a hair clipper according to an aspect of the present disclosure includes: a fixed blade; and a movable blade configured to cut hair by reciprocating sliding with respect to the fixed blade in one direction, in which the fixed blade includes a sliding contact surface on which the movable blade is configured to slide, and a skin contact surface configured to come into contact with skin, in a state where the fixed blade is viewed in the one direction, the skin contact surface is inclined with respect to the sliding contact surface such a manner that a distance between the skin contact surface and the sliding contact surface is decreased toward a distal end side of the fixed blade, the movable blade is configured to be slidable on the sliding contact surface of the fixed blade in an intersecting direction intersecting the one direction, and the fixed blade includes a distal end part including a uniform part with a uniform thickness in a thickness direction intersecting the one direction and the intersecting direction.

A hair clipper according to an aspect of the present disclosure includes the blade of a hair clipper.

According to the present disclosure, it is possible to obtain a blade of a hair clipper and a hair clipper capable of setting a cutting height to be shorter while further reducing stimulation applied to the skin during use.

### BRIEF DESCRIPTION OF THE DRAWINGS

FIG. 1 is a front view illustrating an example of a hair clipper according to an exemplary embodiment;

FIG. 2 is a side view illustrating an example of the hair clipper according to the exemplary embodiment;

FIG. 3 is a sectional view taken along line A-A of FIG. 1;

FIG. 4 is a perspective view illustrating an example of a blade block included in the hair clipper according to the exemplary embodiment;

FIG. 5 is a plan view illustrating an example of the blade block included in the hair clipper according to the exemplary embodiment;

FIG. 6 is a bottom view illustrating an example of the blade block included in the hair clipper according to the exemplary embodiment;

FIG. 7 is a side view illustrating an example of the blade block included in the hair clipper according to the exemplary embodiment;

FIG. 8 is an exploded perspective view illustrating an example of the blade block included in the hair clipper according to the exemplary embodiment;

FIG. 9 is a view illustrating an example of a cutting height adjustment mechanism included in the hair clipper according to the exemplary embodiment, and is a sectional view illustrating a state in which a cutting height is maximized;

FIG. 10 is a view illustrating an example of the cutting height adjustment mechanism included in the hair clipper according to the exemplary embodiment, and is a sectional view illustrating a state in which the cutting height is minimized;

FIG. 11 is a view illustrating an example of the cutting height adjustment mechanism included in the hair clipper according to the exemplary embodiment, and is a perspective view illustrating a state in which the cutting height is maximized from an inside;

FIG. 12 is a view illustrating an example of the cutting height adjustment mechanism included in the hair clipper according to the exemplary embodiment, and is a perspective view illustrating a state in which the cutting height is minimized from an inside;

FIG. 13 is a perspective view of an example of a fixed blade included in the blade block according to the exemplary embodiment as viewed from a back side;

FIG. 14 is a side view illustrating an example of the fixed blade included in the blade block according to the exemplary embodiment;

FIG. 15 is a perspective view illustrating a positional relationship between a movable blade and the fixed blade when a maximum cutting height is set;

FIG. 16 is a side view for explaining a positional relationship between the movable blade and the fixed blade when the maximum cutting height is set;

FIG. 17 is a perspective view illustrating a positional relationship between the movable blade and the fixed blade when a minimum cutting height is set;

FIG. 18 is a side view for explaining a positional relationship between the movable blades and the fixed blades when the minimum cutting height is set;

FIG. 19 is an enlarged side view illustrating a distal end part of the fixed blade included in the blade block according to the exemplary embodiment;

FIG. 20 is an enlarged bottom view illustrating a fixed blade bar and a fixed blade groove of the fixed blade according to the exemplary embodiment;

FIG. 21 is an enlarged side view illustrating a distal end part of a fixed blade included in a blade block according to a first modification example; and

FIG. 22 is a side view illustrating a fixed blade included in a blade block according to a second modification example.

### DETAILED DESCRIPTIONS

Hereinafter, an exemplary embodiment will be described in detail with reference to the drawings. It is noted that a more detailed description than need may be omitted. For example, the detailed description of already well-known matters and the overlap description of substantially the same configurations may be omitted.

Note that the accompanying drawings and the following description are only presented to help those skilled in the art fully understand the present disclosure and are not intended to limit the subject matters described in the claims.

Furthermore, in the following exemplary embodiment and its modification examples, a description will be given while defining a reciprocating sliding direction of a movable blade with respect to a fixed blade as width direction Y. Moreover, a direction in which the movable blade slides with respect to the fixed blade is defined as front-back direction X. A vertical direction in a state where the movable blade is located below the fixed blade and a sliding contact surface of the fixed blade is horizontal is defined as vertical direction Z.

Therefore, in the following exemplary embodiment and its modification examples, width direction Y, which is a direction in which the movable blade reciprocates and slides with respect to the fixed blade, corresponds to one direction. Front-back direction X, which is a direction in which the movable blade slides with respect to the fixed blade, corresponds to an intersecting direction intersecting (that is, orthogonal to) the one direction. The intersecting direction (that is, front-back direction X) is a direction orthogonal to the one direction (that is, width direction Y), and forms a sliding contact surface between the movable blade and the fixed blade together with the one direction (that is, width direction Y). Vertical direction Z corresponds to a thickness direction that is a direction intersecting (that is, orthogonal to) the one direction (that is, width direction Y) and the intersecting direction (that is, front-back direction X).

Note that, when a hair clipper is described in the following exemplary embodiment and its modification examples, a side on which a switch unit is provided is defined as a front face.

### EXEMPLARY EMBODIMENT

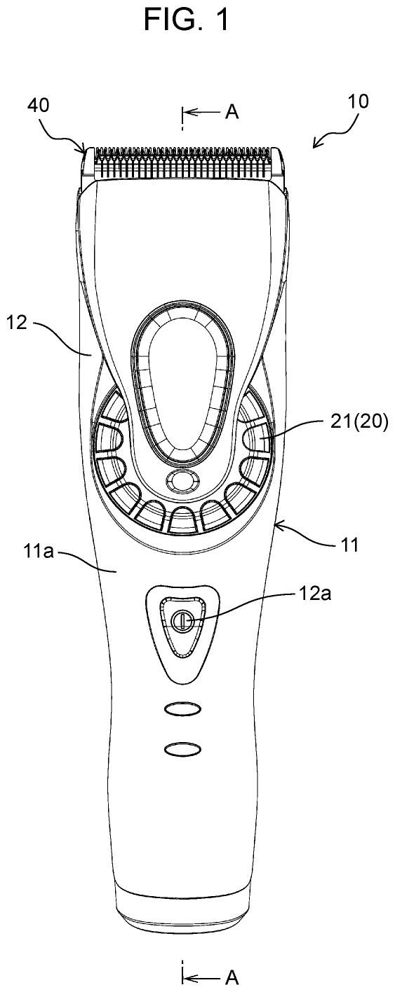

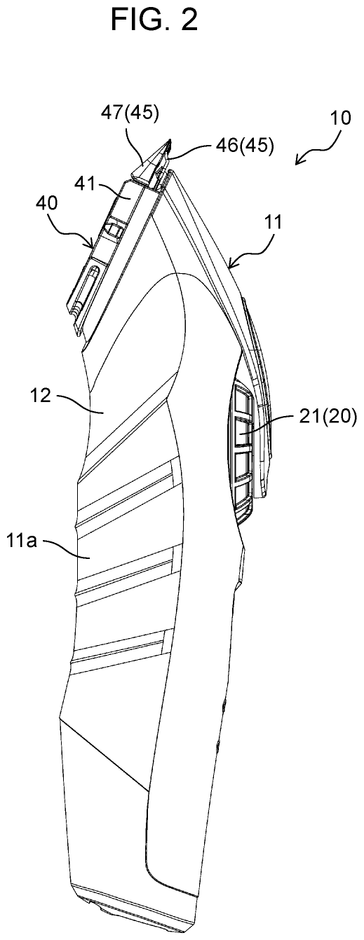

FIG. 1 is a front view illustrating an example of hair clipper 10 according to an exemplary embodiment. FIG. 2 is a side view illustrating an example of hair clipper 10 according to the exemplary embodiment. As illustrated in FIG. 1 and FIG. 2, hair clipper 10 according to the present exemplary embodiment includes main body 11 and blade block 40 detachably attached to main body 11. In the present exemplary embodiment, main body 11 has an elongated shape, and grip 11a (that is, a grip part) that can be held by hand is formed on main body 11.

This hair clipper 10 is, for example, a device for treating or arranging hair of a user or the like by cutting the hair of the user or the like to a desired length. Specifically, blade block 40 includes fixed blade 47 made of metal and movable blade 46 made of metal. Movable blade 46 reciprocates and slides in width direction Y (that is, a sliding direction) with respect to fixed blade 47. Blade block 40 is attached to main body 11, and movable blade 46 is reciprocally slid in width direction Y with respect to fixed blade 47 by using electric motor 14 housed in main body 11 as a drive source, whereby hair clipper 10 functions as a device for sandwiching and cutting hair between fixed blade 47 and movable blade 46.

Furthermore, in the present exemplary embodiment, main body 11 includes housing 12 forming a substantially S-shaped outer shell in a side view. Housing 12 can be formed using, for example, a material such as a synthetic resin, and is attached to a front face of housing 12 such that operation switch 12a can be pushed inward in a state of being exposed to an outside.

Furthermore, in the present exemplary embodiment, housing 12 is formed by joining a plurality of divided bodies, and a cavity is formed inside housing 12 formed by joining the divided bodies. Various electric components are accommodated in the cavity. These plurality of divided bodies can be joined by using a screw or by fitting the divided bodies to each other, for example.

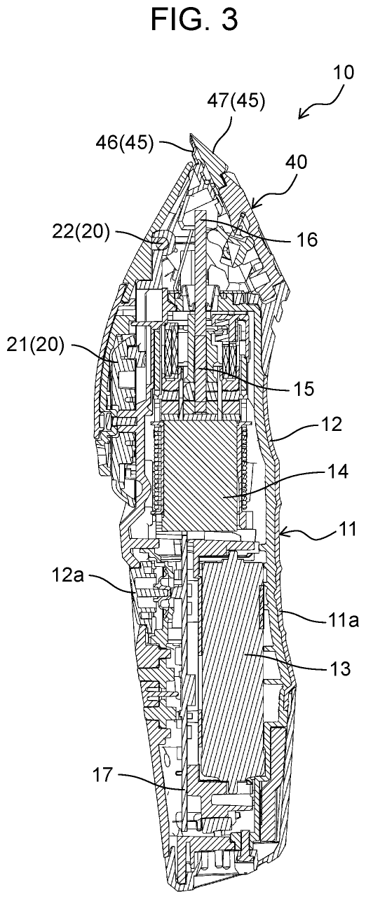

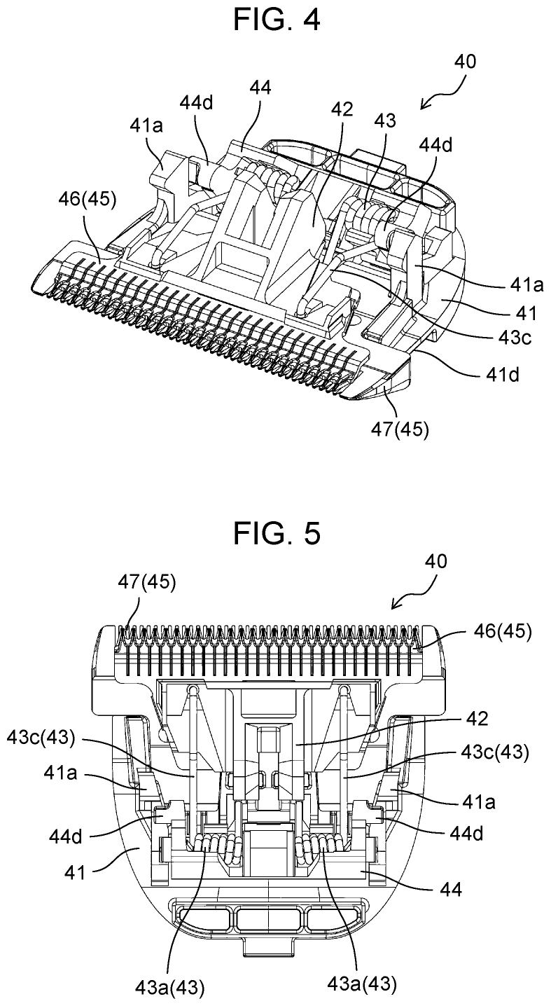

In the present exemplary embodiment, rechargeable battery 13 and electric motor 14 driven by rechargeable battery 13 are accommodated in the cavity formed inside housing 12. Furthermore, in the cavity formed inside housing 12, power transmission mechanism 15 that transmits a rotational driving force of electric motor 14 to blade block 40 and eccentric shaft 16 eccentrically rotationally driven by power transmission mechanism 15 are accommodated. FIG. 3 is a sectional view taken along line A-A of FIG. 1. In the present exemplary embodiment, as illustrated in FIG. 3, eccentric shaft 16 is accommodated in the cavity inside housing 12 in a state where a distal end protrudes toward blade block 40 (that is, an upper side of FIG. 3), and is connected to guide plate 42 (See FIGS. 4, 5, and 7), which will be described later, of blade block 40. Note that it is also possible to supply power from an outside using a power supply cord or the like. Furthermore, the method of driving blade block 40 is not limited to the above-described method, and various methods can be used.

Moreover, controller 17 and the like that control power supply to electric motor 14 according to a pressing operation of operation switch 12a exposed to the outside are accommodated in the cavity formed inside housing 12.

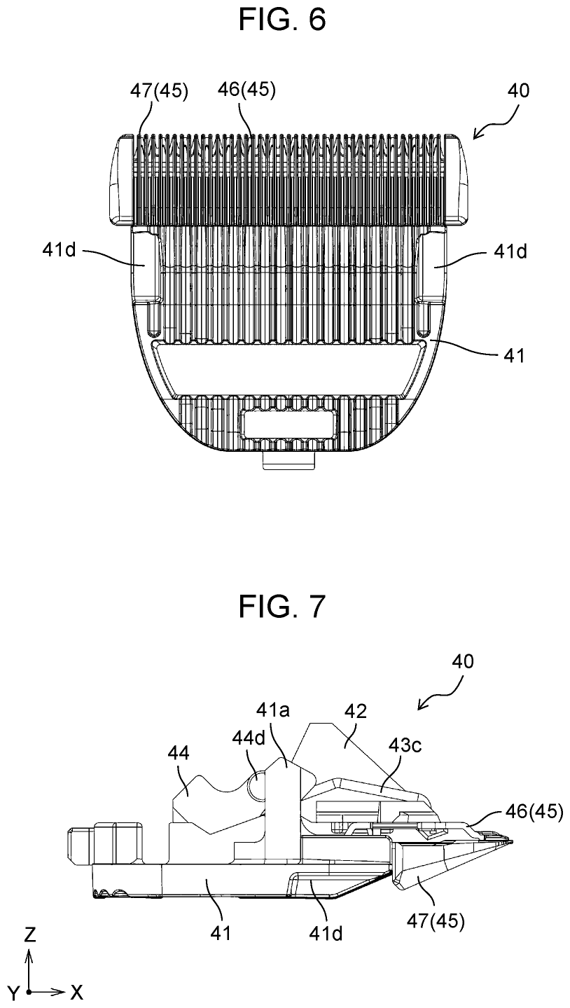

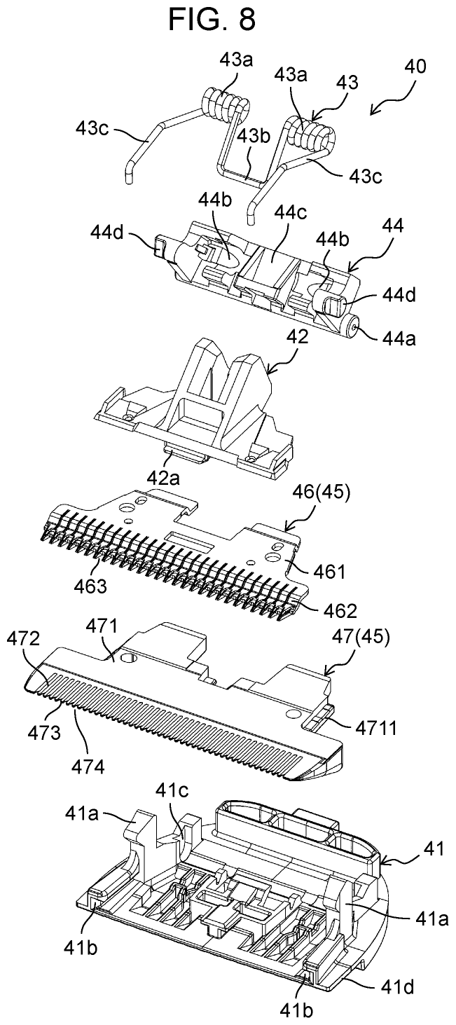

FIG. 4 is a perspective view illustrating an example of blade block 40 included in hair clipper 10 according to the exemplary embodiment. FIG. 5 is a plan view illustrating an example of blade block 40 included in hair clipper 10 according to the exemplary embodiment. FIG. 6 is a bottom view illustrating an example of blade block 40 included in hair clipper 10 according to the exemplary embodiment. FIG. 7 is a side view illustrating an example of blade block 40 included in hair clipper 10 according to the exemplary embodiment. Blade block 40 has a function of cutting hair, and as illustrated in FIGS. 4 to 7, includes blade part 45 (that is, a blade of hair clipper 10) formed by disposing movable blade 46 and fixed blade 47 so as to face each other. Blade part 45 is configured such that movable blade bar 462 (see FIG. 8), which will be described later, of movable blade 46 reciprocally slides in width direction Y with respect to fixed blade bar 472, which will be described later, of fixed blade 47.

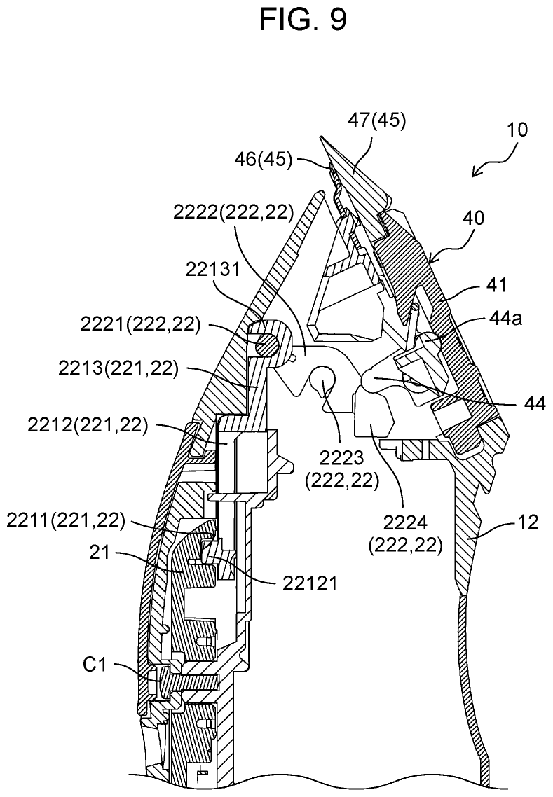

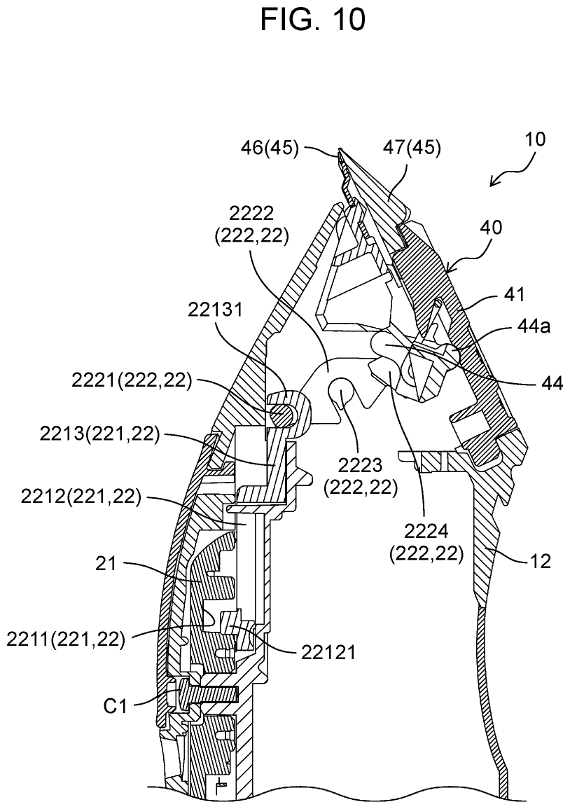

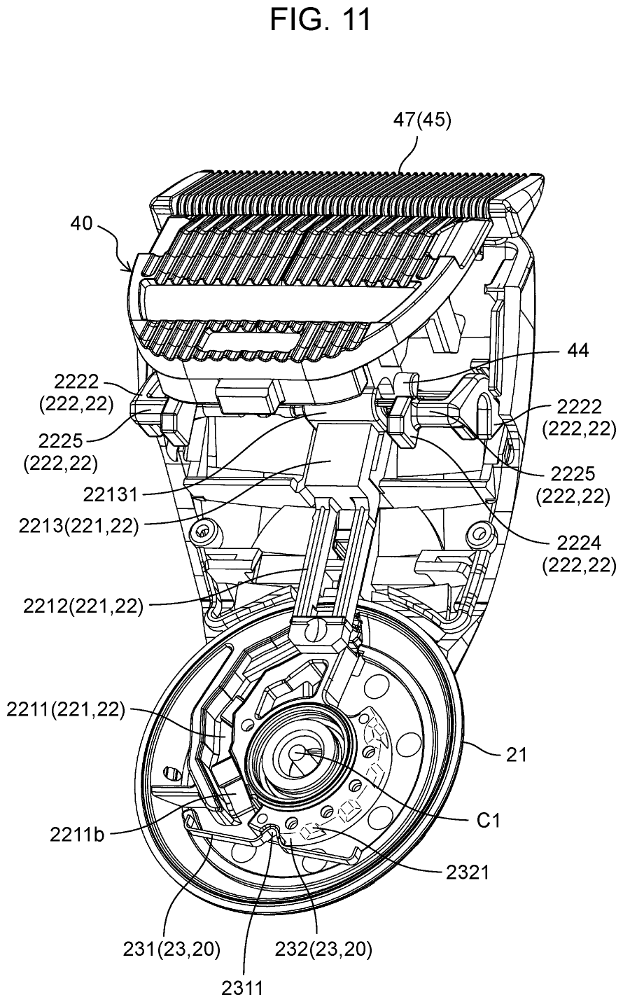

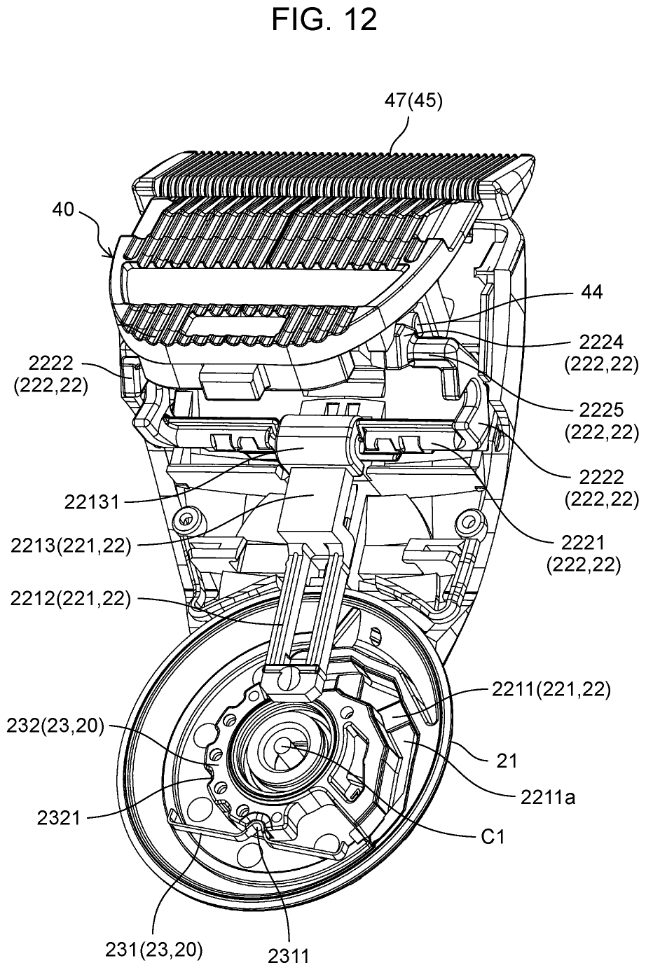

FIG. 8 is an exploded perspective view illustrating an example of blade block 40 included in hair clipper 10 according to the exemplary embodiment. As illustrated in FIG. 8, blade block 40 further includes fixing plate 41 made of resin on which blade part 45 is disposed, and guide plate 42 made of resin and fixed to movable blade 46. Furthermore, blade block 40 includes metallic push-up spring 43 that presses movable blade 46 toward fixed blade 47, and resinous switching lever 44 that holds push-up spring 43. FIG. 9 is a view illustrating an example of a cutting height adjustment mechanism included in hair clipper 10 according to the exemplary embodiment, and is a sectional view illustrating a state in which a cutting height is maximized FIG. 10 is a view illustrating an example of a cutting height adjustment mechanism included in hair clipper 10 according to the exemplary embodiment, and is a sectional view illustrating a state in which a cutting height is minimized FIG. 11 is a view illustrating an example of a cutting height adjustment mechanism included in hair clipper 10 according to the exemplary embodiment, and is a perspective view illustrating a state in which a cutting height is maximized from an inside. FIG. 12 is a view illustrating an example of a cutting height adjustment mechanism included in hair clipper 10 according to the exemplary embodiment, and is a perspective view illustrating a state in which a cutting height is minimized from an inside. In the present exemplary embodiment, switching lever 44 is held by fixing plate 41 in a state of being relatively rotatable with respect to fixing plate 41, and can fall between a falling attitude illustrated in FIG. 9 and a standing attitude illustrated in FIG. 10.

As illustrated in FIGS. 4 to 10 (particularly, FIG. 8), fixing plate 41 is a member fixed to main body 11 in a state where fixed blade 47 is fixed, and includes hook part 41a for engaging with main body 11, insertion groove 41b for inserting and holding insertion protrusion 4711 of fixed blades 47, and holding groove 41c that opens upward. Columnar part 44a, which will be described later, of switching lever 44 is inserted and held in holding groove 41c in a state of being relatively rotatable with respect to fixing plate 41.

Guide plate 42 is a member that is connected to eccentric shaft 16 and reciprocates in width direction Y in a state where blade block 40 is attached to main body 11, and movable blade 46 is fixed to guide plate 42. In the present exemplary embodiment, guide plate 42 includes hook part 42a with which movable blade 46 is engaged, and hook part 42a and a heat seal fix movable blade 46 to guide plate 42. Movable blade 46 reciprocally slides in width direction Y with respect to fixed blade 47 in conjunction with reciprocation of guide plate 42 in width direction Y.

Push-up spring 43 is a member that presses movable blade 46 toward fixed blade 47 to more reliably bring movable blade bar 462 and fixed blade bar 472, both of which will be described later, into sliding contact with each other, and can be formed by, for example, a torsion spring. In the present exemplary embodiment, push-up spring 43 includes a pair of coil parts 43a held by switching lever 44 and connecting part 43b held by switching lever 44 and connecting the pair of coil parts 43a. Furthermore, push-up spring 43 includes arm part 43c that is connected to an opposite side of connection part 43b of each coil part 43a, is fixed to movable blade 46, and presses movable blade 46 toward fixed blade 47.

Note that, in the present exemplary embodiment, an attachment (not illustrated) can be attached to blade block 40, and a cutting height of hair clipper 10 can be changed by attaching the attachment. In the present exemplary embodiment, as illustrated in FIG. 6, attachment port 41d for attaching the attachment is provided on a back surface side of fixing plate 41.

Moreover, hair clipper 10 according to the present exemplary embodiment is configured to change a cutting height of hair without using the attachment, and as illustrated in FIGS. 1 to 3, main body 11 includes cutting height adjustment mechanism 20. By operating cutting height adjustment mechanism 20, a tilting operation of switching lever 44 is performed, and the cutting height of the hair is changed by the tilting operation of switching lever 44.

As illustrated in FIG. 8, in the present exemplary embodiment, switching lever 44 includes columnar part 44a that is inserted and held in holding groove 41c of fixing plate 41 in a state of being relatively rotatable with respect to fixing plate 41. Furthermore, switching lever 44 includes accommodating recess 44b in which coil part 43a of push-up spring 43 is accommodated in a fitted state, and accommodating recess 44c in which a connecting part of push-up spring 43 is accommodated. Moreover, switching lever 44 includes protruding part 44d operated by transmission mechanism 22. Switching lever 44 is held by fixing plate 41 in a state of being biased toward a side of the falling attitude by push-up spring 43.

On the other hand, as illustrated in FIGS. 9 to 12, cutting height adjustment mechanism 20 includes dial 21 for cutting height adjustment rotatably attached to main body 11, and transmission mechanism 22 that performs the tilting operation of switching lever 44 of blade block 40 in conjunction with the rotation of dial 21. In the present exemplary embodiment, dial 21 for adjusting a cutting height is provided closer to blade block 40 (that is, the upper side of FIG. 1) than operation switch 12a on the front side of housing 12 so as to be rotatable relative to housing 12. At this time, dial 21 can be relatively rotated with respect to housing 12 about rotation axis C1 extending in a left-right direction (that is, one type of horizontal direction) in the state illustrated in FIG. 9. Transmission mechanism 22 is accommodated in the cavity formed inside housing 12, and includes first conversion mechanism 221 and second conversion mechanism 222.

Here, first conversion mechanism 221 is a mechanism that converts the rotation (that is, reciprocating rotational motion) of dial 21 about rotation axis C1 into a reciprocating linear motion of dial 21 in a radial direction (that is, a vertical direction in the state illustrated in FIG. 9), and includes groove 2211. As illustrated in FIGS. 11 and 12, groove 2211 is formed inside dial 21, and has a curved shape such that a distance from rotation axis C1 decreases from one end 2211a toward other end 2211b.

Furthermore, first conversion mechanism 221 includes rod 2212 having pin 22121 movably inserted into groove 2211, and slider 2213 provided at a distal end of rod 2212. When dial 21 is rotated, pin 22121 moves in groove 2211 in conjunction with the rotation of dial 21. In this way, rod 2212 and slider 2213 reciprocate linearly in the radial direction (that is, the vertical direction in the state illustrated in FIG. 9) of dial 21 in conjunction with the movement of pin 22121 in groove 2211.

On the other hand, second conversion mechanism 222 is a mechanism that converts the reciprocating linear motion converted by first conversion mechanism 221 into rotation (that is, reciprocating rotational motion) about a rotation axis extending in width direction Y (that is, one direction), and includes operation shaft 2221. Operation shaft 2221 is attached to hook part 22131 provided in slider 2213 in a state of extending in width direction Y (that is, one direction), and reciprocates linearly in the radial direction (that is, the vertical direction in the state illustrated in FIG. 9) of dial 21 together with slider 2213.

Moreover, second conversion mechanism 222 includes rotary member 2222 having one end connected to operation shaft 2221, and rotary shaft 2223 extending in width direction Y (that is, one direction) and to which rotary member 2222 is rotatably attached. In the present exemplary embodiment, a pair of rotary members 2222 is provided continuously at both ends in width direction Y (that is, one direction) of operation shaft 2221. Furthermore, second conversion mechanism 222 includes action member 2224 that is connected to the other end of rotary member 2222 and performs the tilting operation of switching lever 44, and connecting shaft 2225 that extends in width direction Y (that is, one direction) and connects rotary member 2222 and action member 2224.

When operation shaft 2221 is linearly reciprocated in the radial direction (that is, the vertical direction in the state illustrated in FIG. 9) of dial 21, rotary member 2222 rotates about rotary shaft 2223 in conjunction with the linear reciprocation of operation shaft 2221. Thus, action member 2224 connected to rotary member 2222 via connecting shaft 2225 rotates in conjunction with the other end of rotary member 2222, and the tilting operation of switching lever 44 is performed by the rotation of action member 2224.

In the present exemplary embodiment, when dial 21 is rotated in a forward direction, slider 2213 and operation shaft 2221 linearly move in a downward direction in the state illustrated in FIGS. 9 and 10. With the downward movement of operation shaft 2221, rotary member 2222 rotates about rotary shaft 2223. At this time, rotary member 2222 rotates so that one end side connected to operation shaft 2221 moves downward and the other end to which action member 2224 is connected moves upward. Furthermore, action member 2224 moves upward along with the upward movement of the other end side of rotary member 2222. Then, by moving action member 2224 upward, switching lever 44 is rotated toward a side of the standing attitude against a biasing force of push-up spring 43. In this way, movable blade 46 slides toward a side of the distal end (that is, a front side in front-back direction X) while holding the pressed state with respect to fixed blade 47 via push-up spring 43 and guide plate 42.

On the other hand, when dial 21 is rotated in a reverse direction, slider 2213 and operation shaft 2221 linearly move in an upward direction in the state illustrated in FIGS. 9 and 10. With the upward movement of operation shaft 2221, rotary member 2222 rotates about rotary shaft 2223. At this time, rotary member 2222 rotates so that one end side connected to operation shaft 2221 moves upward and the other end to which action member 2224 is connected moves downward. Furthermore, action member 2224 moves downward along with the downward movement of the other end side of rotary member 2222. Then, by moving action member 2224 downward, switching lever 44 is rotated to the side of the falling attitude by a biasing force of push-up spring 43. In this way, movable blade 46 slides toward a root side (that is, a rear side in front-back direction X) while holding the pressed state against fixed blade 47 via push-up spring 43 and guide plate 42.

As described above, in the present exemplary embodiment, when dial 21 is rotated in the forward direction, movable blade 46 slides toward the distal end side of fixed blade 47, and when dial 21 is rotated in the reverse direction, movable blade 46 slides toward the root side of fixed blade 47. Note that, in the present exemplary embodiment, turning dial 21 counterclockwise in the state illustrated in FIG. 1 is expressed as turning dial 21 in the forward direction, and turning dial 21 clockwise in the state illustrated in FIG. 1 is expressed as turning dial 21 in the reverse direction.

At this time, movable blade 46 slides on tapered part 4721 (see FIG. 13) of fixed blade 47, which will be described later. That is, in the present exemplary embodiment, movable blade 46 is slid between the root side and the distal end side on tapered part 4721 of fixed blade 47. In this way, the cutting height of the hair is changed.

Note that, in the present exemplary embodiment, when dial 21 is rotated in the forward direction and switching lever 44 is rotated by a predetermined amount from the initial position to the side of the standing attitude, protruding part 44d comes into contact with hook part 41a of fixing plate 41 to restrict further standing. That is, by bringing protruding part 44d into contact with hook part 41a of fixing plate 41 to regulate further standing of switching lever 44, sliding of movable blade 46 toward the distal end side is regulated. Furthermore, in the present exemplary embodiment, when switching lever 44 is at the initial position, movable blade 46 is located closest to the root side of fixed blade 47 (that is, a state in which the cutting height is set to be the highest). When the standing of switching lever 44 is regulated by protruding part 44d, movable blade 46 is located closest to the distal end side of fixed blade 47 (that is, a state in which the cutting height is set to be the shortest).

Furthermore, as illustrated in FIG. 8, movable blade 46 includes main body 461, a plurality of movable blade bars 462 arranged side by side in width direction Y on one end side (that is, the front side in front-back direction X) of main body 461, and a plurality of movable blade grooves 463, each of which is formed between adjacent movable blade bars 462.

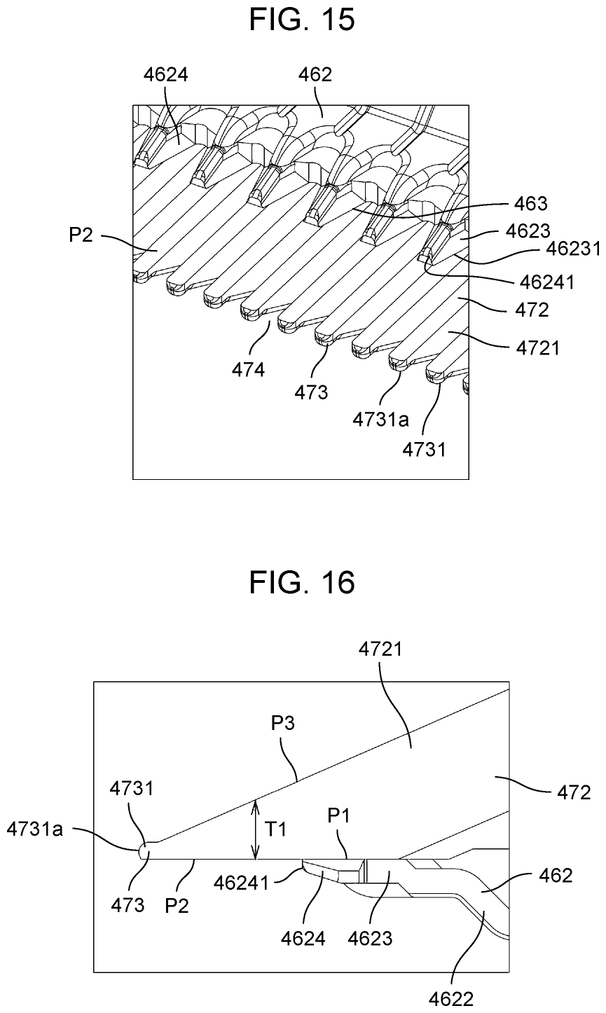

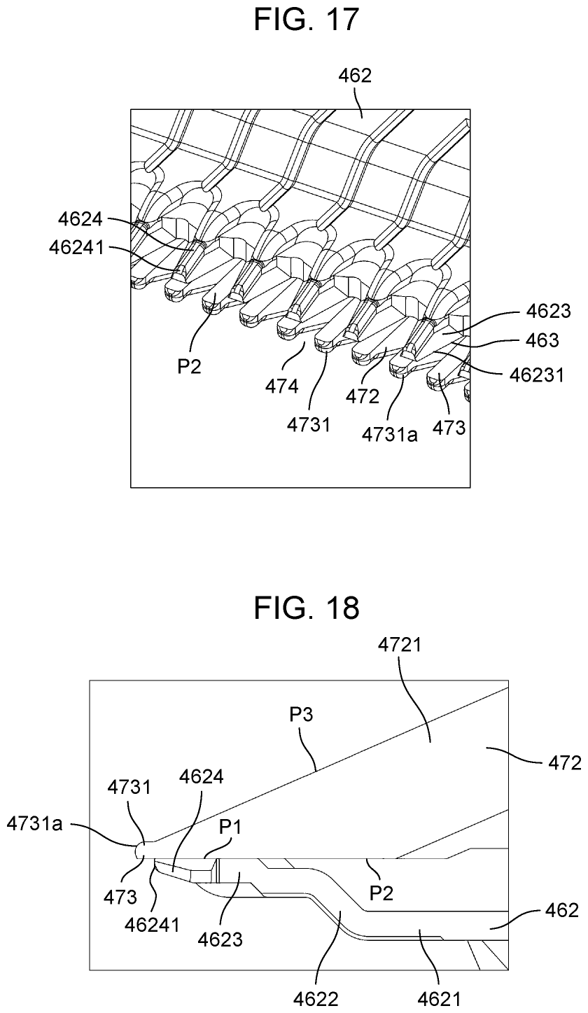

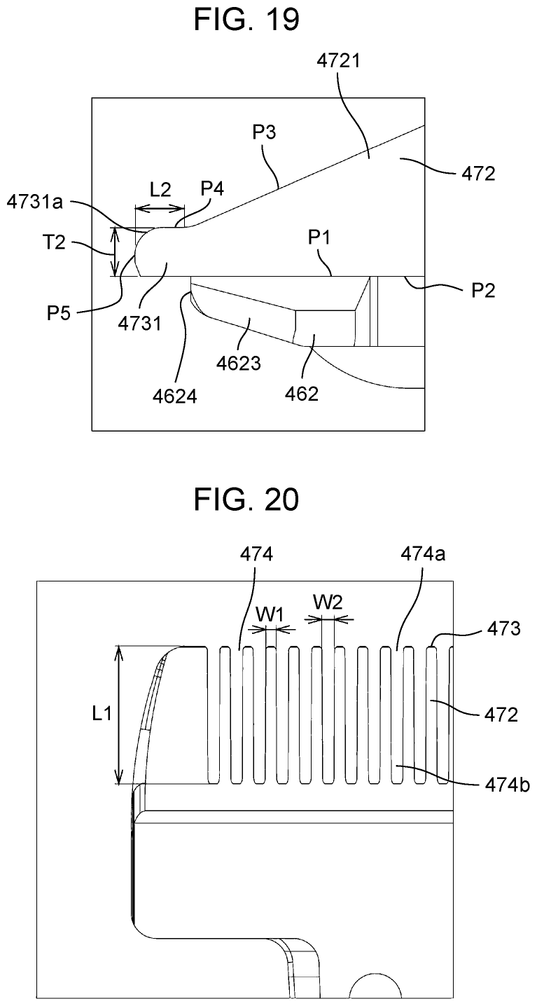

FIG. 15 is a perspective view illustrating a positional relationship between movable blade 46 and fixed blade 47 when a maximum cutting height is set. FIG. 16 is a side view illustrating a positional relationship between movable blade 46 and fixed blade 47 when a maximum cutting height is set. FIG. 17 is a perspective view illustrating a positional relationship between movable blade 46 and fixed blade 47 when a minimum cutting height is set. FIG. 18 is a side view illustrating a positional relationship between movable blade 46 and fixed blade 47 when a minimum cutting height is set. FIG. 19 is an enlarged side view illustrating a distal end part of fixed blade 47 included in blade block 40 according to the exemplary embodiment. Each movable blade bar 462 is formed so as to protrude forward in front-back direction X from main body 461, and includes root part 4621 (see FIG. 18) continuously provided to main body 461. Furthermore, movable blade bar 462 includes bent part 4622 (see FIGS. 16 and 18) that is provided continuously from root part 4621 and is bent such that a distal end side of movable blade bar 462 faces fixed blade 47, and cutting part 4623 (see FIGS. 15 to 19) that is provided continuously from bent part 4622 and is capable of cutting hair. Therefore, in the present exemplary embodiment, a surface of cutting part 4623 on the side of fixed blade 47 is sliding contact surface P1 (see FIGS. 16, 18 and 19) of movable blade 46.

Furthermore, edge 46231 (see FIGS. 15 and 17) is formed on each side in width direction Y of the cutting part 4623, and the hair can be more reliably cut by edge 46231.

Moreover, in the present exemplary embodiment, as illustrated in FIGS. 15 and 16, a surface of distal end 4624 of movable blade bar 462 opposite to sliding contact surface P1 is rounded. That is, curved part 46241 is formed on a surface of distal end 4624 of movable blade bar 462 opposite to sliding contact surface P1. In this way, it is possible to reduce the stimulation applied to the skin by blade part 45 when the side of movable blade 46 is used in contact with the skin.

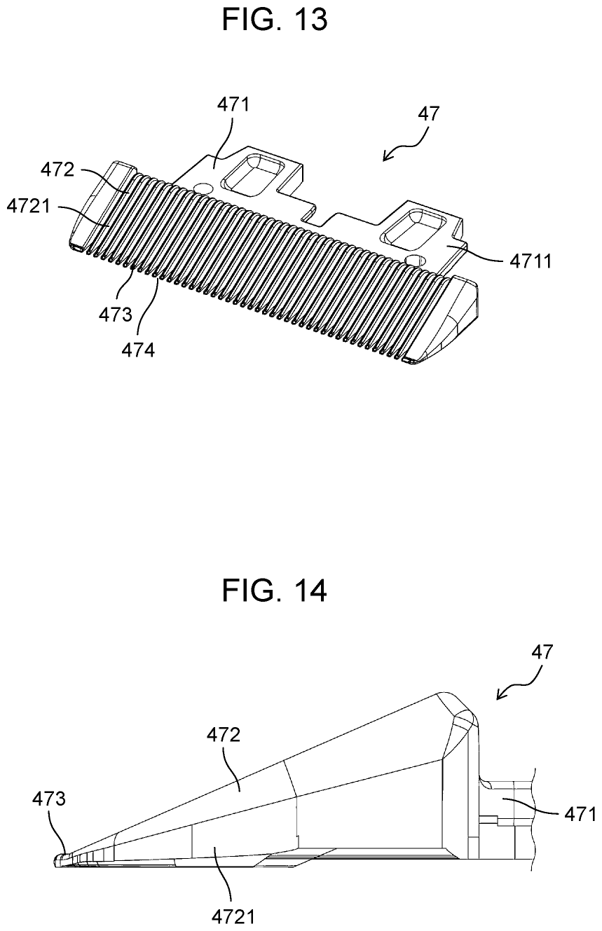

FIG. 13 is a perspective view of an example of fixed blade 47 included in blade block 40 according to the exemplary embodiment as viewed from a back side. FIG. 14 is a side view illustrating an example of fixed blade 47 included in blade block 40 according to the exemplary embodiment. Fixed blade 47 includes main body 471, a plurality of fixed blade bars 472 arranged side by side in width direction Y on one end side (that is, the front side in front-back direction X) of main body 471, and a plurality of fixed blade grooves 474, each of which is formed between adjacent fixed blade bars 472.

As illustrated in FIGS. 13 and 14, each of fixed blade bars 472 has tapered part 4721 that tapers toward a distal end side (that is, the front side in front-back direction X). In the present exemplary embodiment, fixed blade 47 includes sliding contact surface P2 (see FIGS. 15 to 19) with which movable blade 46 can come into sliding contact, and skin contact surface P3 (see FIGS. 16, 18 and 19) with which skin can come into contact. In side view of fixed blade bar 472 (that is, fixed blade 47 is viewed along width direction Y), skin contact surface P3 is inclined with respect to sliding contact surface P2 such that a distance between skin contact surface P3 and sliding contact surface P2 becomes shorter on the distal end side (that is, the front side in front-back direction X). Accordingly, fixed blade bar 472 is formed with tapered part 4721 having thickness T1 that gradually decreases from the root side toward the distal end side.

Movable blade 46 is slid in front-back direction X on sliding contact surface P2 of tapered part 4721. That is, a sliding range of movable blade 46 is set on sliding contact surface P2 of tapered part 4721. Specifically, as illustrated in FIGS. 15 and 16, sliding contact surface P1 of movable blade 46 comes into contact with sliding contact surface P2 of tapered part 4721 in a state where movable blade 46 is located closest to the root side of fixed blade 47 (that is, a state in which the cutting height is set to be the highest). As illustrated in FIGS. 17 and 18, even when movable blade 46 is located closest to the distal end side of fixed blade 47 (that is, a state in which the cutting height is set to be the shortest), sliding contact surface P1 of movable blade 46 is brought into contact with sliding contact surface P2 of tapered part 4721.

Here, in the present exemplary embodiment, tapered part 4721 is formed such that a cutting height in a state where movable blade 46 is located closest to the root side of fixed blade 47 is 1.5 mm, and a cutting height in a state where movable blade 46 is located closest to the distal end side of fixed blade 47 is 0.3 mm. The cutting height can be changed stepwise to 1.5 mm, 1.2 mm, 0.9 mm, 0.6 mm, and 0.3 mm That is, by operating dial 21 for adjusting a cutting height, the cutting height can be set to a plurality of levels between 1.5 mm and 0.3 mm (inclusive).

In the present exemplary embodiment, cutting height adjustment mechanism 20 includes holding mechanism 23 capable of holding dial 21 in stages. Holding mechanism 23 holds dial 21 in a stepwise manner so that the cutting height can be changed in a stepwise manner

Specifically, as illustrated in FIGS. 11 and 12, holding mechanism 23 includes holding spring 231 fixed to main body 11 and engaged part 232 formed on a back side of dial 21 and capable of engaging with holding spring 231. In the present exemplary embodiment, dial 21 can be relatively rotated with respect to holding spring 231, and engaged part 232 formed on the back side of dial 21 can also be relatively rotated with respect to holding spring 231. When dial 21 is rotated and a relative position between holding spring 231 and engaged part 232 reaches a predetermined position, holding spring 231 and engaged part 232 are releasably engaged to each other, so that the rotation of dial 21 in both forward and reverse directions is suppressed.

Specifically, engaged part 232 is formed to have a shape including an arc centered on rotation axis C1. On a peripheral surface of engaged part 232, five engaging recesses 2321 recessed toward rotation axis C1 are formed at equal intervals along a circumferential direction. On the other hand, holding spring 231 is formed with engaging protruding part 2311 that protrudes toward the peripheral surface of engaged part 232 and engages with engaging recesses 2321 of engaged part 232.

As described above, in the present exemplary embodiment, the positions of holding spring 231 and engaged part 232 in a state where any one of the five engaging recesses 2321 faces engaging protruding part 2311 are the predetermined positions described above.

Note that the cutting height can be continuously changed between 1.5 mm and 0.3 mm (inclusive). Furthermore, an upper limit or a lower limit of the cutting height can be appropriately set. Moreover, in the case of changing in stages, any number of stages may be used as long as the number of stages is two or more, and the number of stages does not need to be five.

Furthermore, cutting height adjustment mechanism 20 described above is merely an example, and other conventionally known cutting height adjustment mechanisms can be used, as long as movable blade 46 can be slid in front-back direction X with respect to fixed blade 47 in accordance with an operation of a user.

By using blade block 40 as described above, the hair can be cut to a length of 0.3 mm. In this way, in a case where hair cutting height can be set to be shorter, when fixed blade bars 472 of fixed blade 47 merely have tapered part 4721, a distal end of tapered part 4721 may come into contact with skin (for example, scalp) during use of hair clipper 10, thereby giving a large stimulus to the skin (for example, scalp).

Therefore, in the present exemplary embodiment, even when the cutting height can be set to be shorter, it is possible to further reduce the stimulation applied to the skin (for example, scalp) during use. Specifically, as illustrated in FIG. 19, fixed blade bar 472 has distal end part 473 on one end side (that is, the front side in front-back direction X) of tapered part 4721. Distal end part 473 has uniform part 4731 having a uniform thickness in vertical direction Z (that is, a thickness direction intersecting width direction Y and front-back direction X).

In this way, it is possible to further reduce the stimulation given to the skin (for example, scalp) at the time of use.

Furthermore, in the present exemplary embodiment, entire distal end part 473 is uniform part 4731 having a uniform thickness in vertical direction Z. At this time, thickness T2 of uniform part 4731 in vertical direction Z is set to be about 0.35 mm in consideration of biting into the skin (for example, scalp) at the time of use. In this way, a length of 0.3 mm can be realized by actual cutting.

Moreover, in the present exemplary embodiment, uniform part 4731 is formed so as to protrude toward skin contact surface P3 (that is, at least one surface of sliding contact surface P2 and skin contact surface P3). That is, uniform part 4731 is formed so as to protrude only toward skin contact surface P3 out of sliding contact surface P2 and skin contact surface P3.

Consequently, sliding contact surface P2 can be made a flat surface, and movable blade 46 can be prevented from interfering with uniform part 4731 when movable blade 46 is slid on sliding contact surface P2.

Furthermore, if skin contact surface P3 of uniform part 4731 is made to protrude, skin contact surface P3 can be suppressed from being inclined from an appropriate position with respect to the head by bringing the protruding part into contact with the head when fixed blade 47 is brought into contact with a curved surface such as the head. That is, when the fixed blade is used on a surface that is not a flat surface such as a head, fixed blade 47 can be more reliably held at an appropriate position. As a result, hair such as head hair can be more reliably cut to a set length.

Moreover, in the present exemplary embodiment, curved part 4731a is formed at the distal end of fixed blade 47. Specifically, curved part 4731a protruding upward toward the distal end is formed at an upper part of a distal end of uniform part 4731, whereby curved part 4731a is formed at the distal end of fixed blade 47. In other words, in the present exemplary embodiment, fixed blade 47 is formed such that the distal end forms uniform part 4731, and skin contact surface P4 and distal end surface P5 of uniform part 4731 are connected by curved part 4731a having an R shape.

In this way, curved part 4731a can be brought into contact with the skin at the time of use, and the stimulation applied to the skin at the time of use can be more reliably reduced.

A curvature radius of curved part 4731a is preferably about a half of thickness T2 of uniform part 4731 in vertical direction Z. Accordingly, a boundary part between uniform part 4731 and curved part 4731a becomes smooth, and it is possible to suppress an edge from being formed in uniform part 4731. As a result, it is possible to further reduce the stimulation given to the skin (for example, scalp) at the time of use.

Moreover, according to the present exemplary embodiment, length L2 of uniform part 4731 in width direction Y is larger than thickness T2 of uniform part 4731 in vertical direction Z.

Thus, even when curved part 4731a is provided at the distal end of uniform part 4731, uniform part 4731 has a linear part (that is, a flat part).

In the present exemplary embodiment, length L2 of uniform part 4731 in front-back direction X is set to about 0.4 mm

FIG. 20 is an enlarged bottom view illustrating fixed blade bars 472 and fixed blade grooves 474 of fixed blade 47 according to the exemplary embodiment. In the present exemplary embodiment, as illustrated in FIG. 20, each fixed blade groove 474 of fixed blade 47 has different widths W2 in width direction Y between distal end side 474a and back side 474b in front-back direction X.

Specifically, width W2 of fixed blade groove 474 in width direction Y is gradually reduced from distal end side 474a toward back side 474b. In the present exemplary embodiment, width W2 of fixed blade groove 474 in width direction Y is 0.5 mm on distal end side 474a and 0.45 mm on back side 474b.

Accordingly, width W1 of each fixed blade bar 472 on the root side can be increased. In the present exemplary embodiment, width W1 of fixed blade bar 472 in width direction Y is 0.4 mm on distal end side 474a and 0.45 mm on back side 474b.

Note that width W2 of fixed blade groove 474 in width direction Y can be made gradually wider from distal end side 474a toward back side 474b. Thus, the hair can be more reliably introduced to back side 474b.

Furthermore, in the present exemplary embodiment, a depth of fixed blade groove 474 in front-back direction X is set to a depth at which hair can be cut within a movable range of movable blade 46 in front-back direction X. That is, fixed blade groove 474 and movable blade groove 463 overlap with each other in a plan view when the cutting height of the hair is set within a range from 0.3 mm to 1.5 mm inclusive. Specifically, fixed blade groove 474 has depth L1 of about 5.8 mm along front-back direction X. When a cutting height of hair is set within a range from 0.3 mm to 1.5 mm (inclusive), a length from the distal end of fixed blade 47 (that is, the distal end of uniform part 4731) to the distal end of movable blade 46 on sliding contact surface P2 is set to a length of about 0.4 mm to 3.4 mm. In this way, hair can be cut within a movable range of movable blade 46 in front-back direction X.

Furthermore, in the present exemplary embodiment, a sum of width W1 of one fixed blade bar 472 in width direction Y and width W2 of one fixed blade groove 474 in width direction Y ranges from 0.5 mm to 1.0 mm (inclusive). Under such conditions, width W2 of one fixed blade groove 474 in width direction Y is set to 0.3 mm or more.

With such a configuration, width W2 of fixed blade groove 474 in width direction Y is set to such a size that introduction of hair is not hindered. For example, when a thickness of hair is about 0.1 mm, by setting width W2 of fixed blade groove 474 in width direction Y to 0.3 mm or more, at least two or three hairs can be introduced into fixed blade groove 474.

Moreover, when the sum of width W1 of one fixed blade bar 472 in width direction Y and width W2 of one fixed blade groove 474 in width direction Y is 0.5 mm or more and 1.0 mm or less, width W1 of one fixed blade bar 472 in width direction Y can be set to 0.2 mm at minimum. As a result, width W1 of fixed blade bar 472 in width direction Y is prevented from becoming too thin, and a contact area of fixed blade bar 472 with the skin can be prevented from becoming small.

Furthermore, since width W2 of fixed blade groove 474 in width direction Y is 0.8 mm at the maximum, width W2 of fixed blade groove 474 in width direction Y can be prevented from becoming too large. Width W1 of fixed blade bar 472 in width direction Y is at most 0.7 mm, so that width W1 of fixed blade bar 472 in width direction Y can be prevented from becoming too large. This makes it possible to narrow a pitch of the plurality of fixed blade bars 472, thereby ensuring the number of blades (that is, the number of fixed blade bars 472) of fixed blade 47. By making the plurality of fixed blade bars 472 have a narrow pitch, it is possible to prevent skin (for example, scalp) from excessively entering fixed blade groove 474 during use, thereby further improving safety during use.

Thus, when fixed blade bars 472 and fixed blade grooves 474 satisfy the above relationship, it is possible to simultaneously achieve improvement in hair introducibility, securing strength of fixed blade 47, and securing the number of blades (that is, the number of fixed blade bars 472) of fixed blade 47.

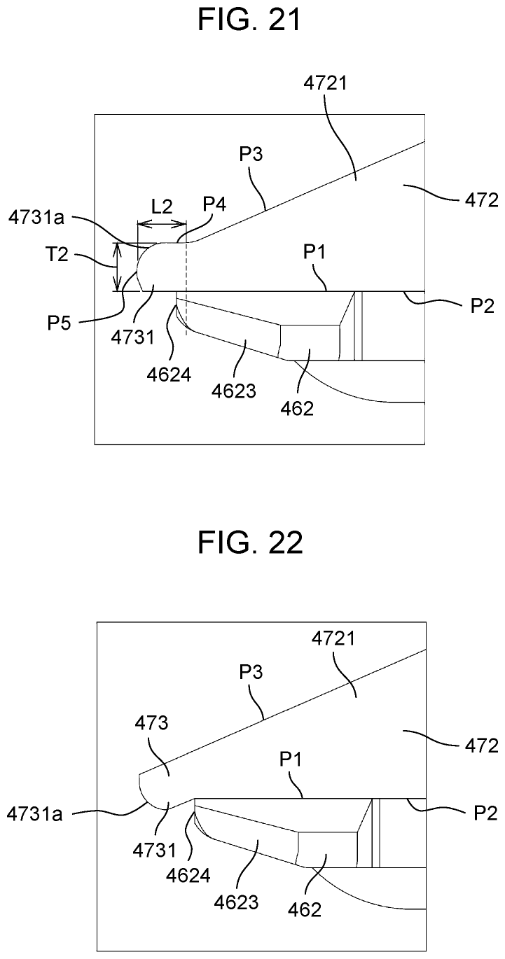

FIG. 21 is an enlarged side view illustrating a distal end part of fixed blade 47 included in blade block 40 according to a first modification example. As illustrated in FIG. 21, when movable blade 46 is located closest to the distal end side of fixed blade 47 (that is, the state in which the cutting height is set to be the shortest), movable blade 46 may face uniform part 4731 in vertical direction Z. That is, when the movable blade 46 is slid in front-back direction X, movable blade 46 may face uniform part 4731 in vertical direction Z.

In this way, design errors and the like can be absorbed, and the cutting height can be made constant even in a case where a position of movable blade 46 is slightly shifted.

FIG. 22 is a side view illustrating fixed blade 47 included in blade block 40 according to a second modification example. As illustrated in FIG. 22, uniform part 4731 may be formed so as to protrude toward skin contact surface P3 (that is, at least one surface of sliding contact surface P2 and skin contact surface P3).

In this way, skin contact surface P3 of fixed blade 47 may be formed into a flat surface, and skin slippage of fixed blade 47 during use may be improved. Furthermore, by forming sliding contact surface P2 with movable blade 46 so as to be a bent surface, movable blade 46 may be prevented from moving toward the distal end side over the bent surface, and may be used more safely.

Uniform part 4731 may protrude toward sliding contact surface P2 and skin contact surface P3.

[Operation and Effects]

Hereinafter, a description will be given of characteristic configurations of the blade of the hair clipper and the hair clipper illustrated in the above-mentioned exemplary embodiment and the modification examples of the exemplary embodiment, and effects obtained thereby.

Blade 45 of the hair clipper described in the exemplary embodiment and the modification examples of the exemplary embodiment includes fixed blade 47, and movable blade 46 that can cut hair by reciprocating sliding in one direction with respect to fixed blade 47. Furthermore, fixed blade 47 also include sliding contact surface P2 on which movable blade 46 can slide, and skin contact surface P3 that can come into contact with skin. Here, in a state where fixed blade 47 is viewed in the one direction, skin contact surface P3 is inclined with respect to sliding contact surface P2 such that a distance between skin contact surface P3 and sliding contact surface P2 becomes short on a distal end side, and movable blade 46 is configured to be slidable on sliding contact surface P2 of fixed blade 47 in an intersecting direction intersecting the one direction. Distal end part 473 of fixed blade 47 includes uniform part 4731 having a uniform thickness in a thickness direction intersecting the one direction and the intersecting direction.

As described above, blade 45 of the hair clipper described in the exemplary embodiment and the modification examples of the exemplary embodiment is configured to be capable of adjusting a cutting height. Distal end part 473 of fixed blade 47 of blade 45 of the hair clipper, which can adjust a cutting height, includes uniform part 4731 having a uniform thickness.

In this way, even when the cutting height is made shorter, it is possible to reduce the stimulation given to the skin by uniform part 4731.

Therefore, with blade 45 of the hair clipper described in the exemplary embodiment and the modification examples of the exemplary embodiment, the cutting height can be set shorter while further reducing the stimulation applied to the skin during use.

Furthermore, movable blade 46 may be configured to slide stepwise in the intersecting direction.

This eliminates the need for the user to finely adjust the cutting height as in the case of continuous sliding, so that the cutting height can be set more easily.

Uniform part 4731 may protrude toward at least one of sliding contact surface P2 and skin contact surface P3.

For example, in the case that uniform part 4731 protrudes toward sliding contact surface P2, the protrusion on sliding contact surface P2 of uniform part 4731 can prevent movable blade 46 from excessively sliding toward the distal end when sliding on sliding contact surface P2.

Furthermore, since skin contact surface P3 can be a flat surface, the skin slippage can be further improved.

On the other hand, when uniform part 4731 protrudes toward skin contact surface P3, sliding contact surface P2 can be a flat surface, so that movable blade 46 can be prevented from interfering with uniform part 4731 when movable blade 46 is slid on sliding contact surface P2.

Furthermore, if skin contact surface P3 of uniform part 4731 is made to protrude, skin contact surface P3 can be suppressed from being inclined from an appropriate position with respect to the head by bringing the protruding part into contact with the head when fixed blade 47 is brought into contact with a curved surface such as the head. That is, when fixed blade 47 is used on a surface that is not a flat surface such as a head, fixed blade 47 can be more reliably held at an appropriate position. As a result, hair such as head hair can be more reliably cut to a set length.

Furthermore, in a case where the uniform part 4731 protrudes toward sliding contact surface P2 and skin contact surface P3, both the effects described above can be obtained.

Furthermore, curved part 4731a may be formed at the distal end of fixed blade 47.

In this way, since curved part 4731a can be brought into contact with the skin at the time of use, it is possible to more reliably reduce the stimulation applied to the skin at the time of use.

Length L2 of uniform part 4731 in the intersecting direction may be larger than thickness T2 in the thickness direction.

Thus, even when curved part 4731a is provided at the distal end of uniform part 4731, uniform part 4731 can be configured to have a straight part (that is, the flat part). As a result, it is possible to prevent movable blade 46 from excessively sliding on sliding contact surface P2 while improving skin contact of fixed blade 47.

When movable blade 46 is slid in the intersecting direction, the movable blade may face uniform part 4731 in the thickness direction.

Accordingly, even when a position of movable blade 46 is slightly shifted due to a design error or the like, the cutting height can be made constant. As a result, the accuracy of the shortest cutting height can be further improved.

Furthermore, fixed blade 47 may include a plurality of fixed blade bars 472 that protrude in the intersecting direction and are arranged side by side in the one direction, and fixed blade grooves 474 provided between fixed blade bars 472 adjacent to each other. In each fixed blade groove 474, width W2 in the one direction may be different between distal end side 474a and back side 474b in the intersecting direction.

For example, when width W2 of distal end side 474a is wider than width W2 of back side 474b, width W1 of root side of fixed blade bar 472 can be increased, so that strength of fixed blade bar 472 can be further improved.

On the other hand, when width W2 of the distal end side 474a is narrower than width W2 of back side 474b, the hair can be more reliably introduced to the back side.

Furthermore, fixed blade 47 may be formed such that a sum of width W1 in the one direction of one fixed blade bar 472 included in the plurality of fixed blade bars 472 and width W2 in the one direction of one fixed blade groove 474 included in the plurality of fixed blade grooves 474 is 0.5 mm or more and 1.0 mm or less, and width W2 in one direction of one fixed blade groove 474 is 0.3 mm or more.

In this way, width W2 of fixed blade groove 474 in the one direction can be set to such a size that hair introduction is not hindered. Moreover, fixed blade bar 472 can be prevented from being reduced in contact area with skin, and fixed blade groove 474 can be prevented from being excessively increased in width W2 in the one direction. As a result, it is possible to suppress the skin from biting into fixed blade groove 474 too much at the time of use.

When width W1 of fixed blade bar 472 in the one direction and width W2 of fixed blade groove 474 in the one direction are set as described above, a contact area of fixed blade bar 472 with a skin can be prevented from being reduced without hindering hair from being introduced into fixed blade groove 474. As a result, it is possible to provide blade 45 of the hair clipper that is easy to use while improving safety.

Furthermore, blade 45 of the hair clipper described in the exemplary embodiment and the modification examples of the exemplary embodiment is advantageous in that hair introducibility can be improved, the strength of fixed blade 47 can be secured, and the number of blades (that is, the number of fixed blade bars 472) of fixed blade 47 can be secured at the same time.

Furthermore, hair clipper 10 described in the exemplary embodiment and the modification examples of the exemplary embodiment includes blade 45 of the hair clipper described above.

Use of such hair clipper 10 makes it possible to set the cutting height to be shorter while further reducing the stimulation applied to the skin during use.

[Others]

Although the contents of the blade of the hair clipper according to the present disclosure have been described above, the present disclosure is not limited to these descriptions, and it is obvious to those skilled in the art that various modifications and improvements can be made.

For example, the present disclosure can be applied to exemplary embodiments in which changes, replacements, additions, omissions, and the like of the configurations described in the exemplary embodiment and the modification examples thereof are made.

Furthermore, it is also possible to make a new exemplary embodiment by combining the constituent elements described in the exemplary embodiment and the modification examples thereof.

Furthermore, in the above-mentioned exemplary embodiment and the modification examples of the exemplary embodiment, width W2 of fixed blade groove 474 in width direction Y is gradually narrowed from distal end side 474a toward back side 474b. However, it is not necessary to gradually narrow from distal end side 474a to back side 474b, and for example, a step may be formed in the middle from distal end side 474a to back side 474b. Furthermore, it is also possible to gradually narrow from distal end side 474a to the middle and to have a constant width from the middle to back side 474b.

Furthermore, in the above-described exemplary embodiment and the modification examples thereof, a configuration in which entire distal end part 473 is uniform part 4731 is exemplified. However, it is not necessary to form entire distal end part 473 as the uniform part 4731, and it is also possible to form a part of distal end part 473 as the uniform part. In this case, the uniform part may be provided on the distal end side of distal end part 473, or the uniform part may be provided on the root side of distal end part 473.

Furthermore, specifications (for example, shape, size, layout, and the like) of the movable blade, the fixed blade, and other details can be changed as appropriate.

As described above, the blade of the hair clipper and the hair clipper according to the present disclosure are capable of setting the cutting height to be shorter while further reducing the stimulation applied to the skin during use, and thus can be applied to a hair clipper for cutting human hair, a hair clipper for pets for cutting pet hair, and the like.

What is claimed is:

1. A blade of a hair clipper, comprising:
a fixed blade; and
a movable blade configured to cut hair by reciprocating and sliding with respect to the fixed blade in one direction,
wherein
the fixed blade comprises a sliding contact surface on which the movable blade is configured to slide, and a skin contact surface configured to come into contact with skin,
in a state where the fixed blade is viewed in the one direction, the skin contact surface is inclined with respect to the sliding contact surface such a manner that a distance between the skin contact surface and the sliding contact surface is decreased toward a distal end side of the fixed blade,
the movable blade is configured to be slidable on the sliding contact surface of the fixed blade in an intersecting direction intersecting the one direction, and
the fixed blade includes a distal end part including a uniform part with a uniform thickness in a thickness direction intersecting the one direction and the intersecting direction.

2. The blade according to claim 1, wherein the movable blade is configured to be slidable stepwise in the intersecting direction.

3. The blade according to claim 1, wherein the uniform part protrudes toward at least one selected from the group consisting of the sliding contact surface and the skin contact surface.

4. The blade according to claim 1, wherein the fixed blade comprises a distal end where a curved part is formed.

5. The blade according to claim 1, wherein the uniform part has a length in the intersecting direction that is greater than a thickness in the thickness direction.

6. The blade according to claim 1, wherein the movable blade is configured to face the uniform part in the thickness direction when being slid in the intersecting direction.

7. The blade according to claim 1, wherein
the fixed blade comprises:
a plurality of fixed blade bars, and
a plurality of fixed blade grooves,
the plurality of fixed blade bars protrude in the intersecting direction and are arranged side by side in the one direction,
each of the plurality of fixed blade grooves is provided between two of the plurality of fixed blade bars included in the plurality of fixed blade bars and adjacent to each other, and
each of the plurality of fixed blade grooves differs in width in the one direction between a distal end side and a back side in the intersecting direction.

8. The blade according to claim 7, wherein the fixed blade is formed such that a sum of a width in the one direction of one of the plurality of fixed blade bars and a width in the one direction of one of the plurality of fixed blade grooves is more than or equal to 0.5 mm and less than or equal to 1.0 mm, and
the width in the one direction of the one of the plurality of fixed blade grooves is more than or equal to 0.3 mm.

9. A hair clipper comprising the blade according to claim 1.
